(19) United States
(12) Patent Application Publication
(10) Pub. No.: US 2010/0293765 A1
(43) Pub. Date: Nov. 25, 2010

(54) Tensioning Apparatus for Strap

(76) Inventor: Han-Ching Huang, Taichung (TW)

Correspondence Address: Muncy, Geissler, Olds & Lowe, PLLC, 4000 Legato Road, Suite 310, FAIRFAX, VA, 22033, US

(21) Appl. No.: 12/470,536

(22) Filed: May 22, 2009

(51) Int. Cl. B25B 25/00

(52) U.S. Cl. 24/68 CD

(57) ABSTRACT

A tensioning apparatus includes a first shaft and a strap wound on the first shaft such that the strap has first and second portions extending in opposite directions, and the first portion of the strap is collected on the first shaft by operably moving the rotating shaft. The tensioning apparatus further includes a reeling device for collecting the second portion of the strap. Furthermore, the reeling device includes a ratcheting mechanism that facilitates collection of the strap.

### BACKGROUND OF THE INVENTION

1. Field of the Invention

The present invention relates to a tensioning apparatus for a strap.

2. Description of the Related Art

U.S. Pat. No. 7,296,326 shows a tensioning apparatus including a reeling device. The reeling device is rotatably mounted between two sidewalls of a lever. The reeling device includes a shaft and a slot therein and two knobs connected to proximal and distal ends of the shaft respectively. User can insert the end of the strap through the slot of the shaft and turn the knob to wind the strap on the shaft. Furthermore, user generally grips the shaft to operably move the lever. However, when the strap is collected on the shaft, the strap would obstruct user to operate the grip. Another problem is that when turning the knob in a direction to wind the strap, it has sometimes happened that the knob is liable to turn in an opposite direction to unwind the strap.

The present invention is, therefore, intended to obviate or at least alleviate the problems encountered in the prior art.

### SUMMARY OF THE INVENTION

According to the present invention, a tensioning apparatus includes a frame, a first shaft rotatably mounted on the frame, and a lever connected with the first shaft and operably pivoted with respect to the frame to rotate the first shaft. Additionally, the lever further includes a gripping portion mounted thereon and used for pivoting the lever. A reeling device includes a second shaft rotatably mounted on the lever. Further, a ratcheting mechanism includes a ratchet member mounted on the second shaft and rotated with the second shaft, a pawl operably moveable between a first position in engagement with the ratchet member and a second position disengaged from the ratchet member, and an elastic element including a first end mounted on the lever and a second end connected with the pawl for biasably engaging the pawl with the ratchet member. Furthermore, a strap is inserted through the first shaft and includes first and second portions extending in opposite directions, with the first shaft rotatable to collect the first portion of the strap, and with the reeling device rotatable to collect the second portion of the strap.

### BRIEF DESCRIPTION OF THE DRAWINGS

FIG. 1 is a perspective view of a tensioning apparatus in accordance with the present invention.

FIG. 2 is another perspective view of the tensioning apparatus taken at a different angle than that of FIG. 1.

FIG. 3 is a partial, exploded perspective view of a reeling device and a ratcheting mechanism of the tensioning apparatus.

FIG. 4 is a perspective view showing a strap wound on a first shaft and with two portions extending oppositely.

FIG. 5 is a side view of the tensioning apparatus shown in FIG. 4.

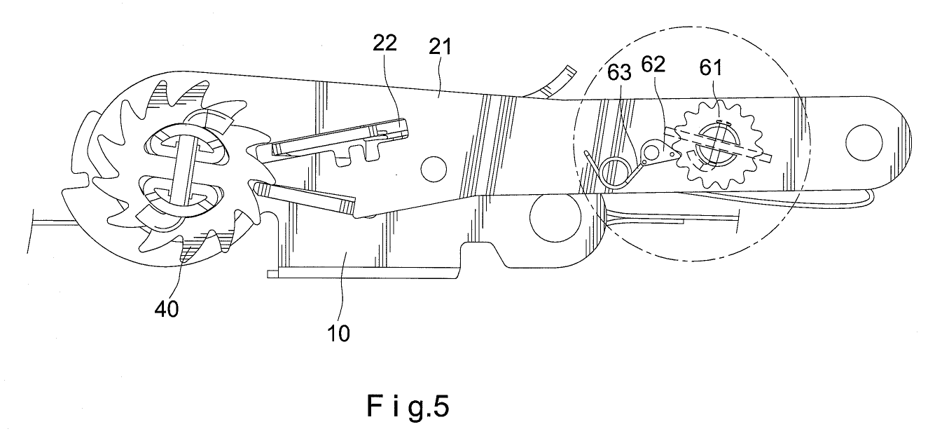

FIG. 6 is a partial, enlarged view of FIG. 5.

FIG. 7 is an extended view of FIG. 5 and shows the operational movement of the reeling device and the ratcheting mechanism.

FIG. 8 is an extended view of FIG. 5 and in which the ratcheting mechanism is disengaged with the reeling device.

FIG. 9 is a cross-sectional view taken along line 9-9 of FIG. 4.

FIG. 10 is an extended view of FIG. 9 and shows the strap is receivable by the reeling device.

FIG. 11 is an extended view of FIG. 10 and shows the strap collected on the reeling device.

### DETAILED DESCRIPTION OF THE PREFERRED EMBODIMENT

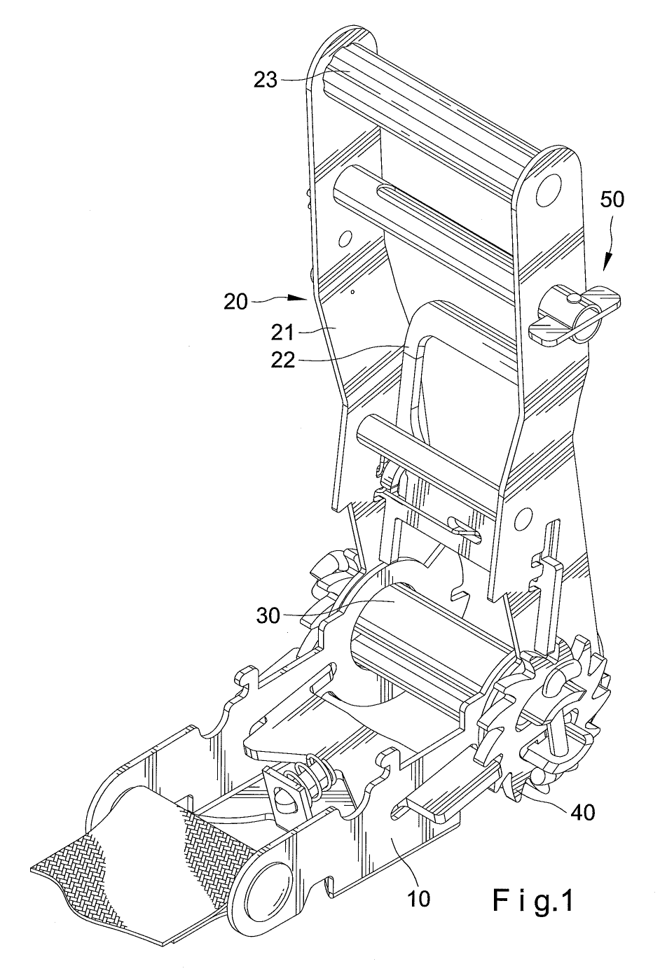

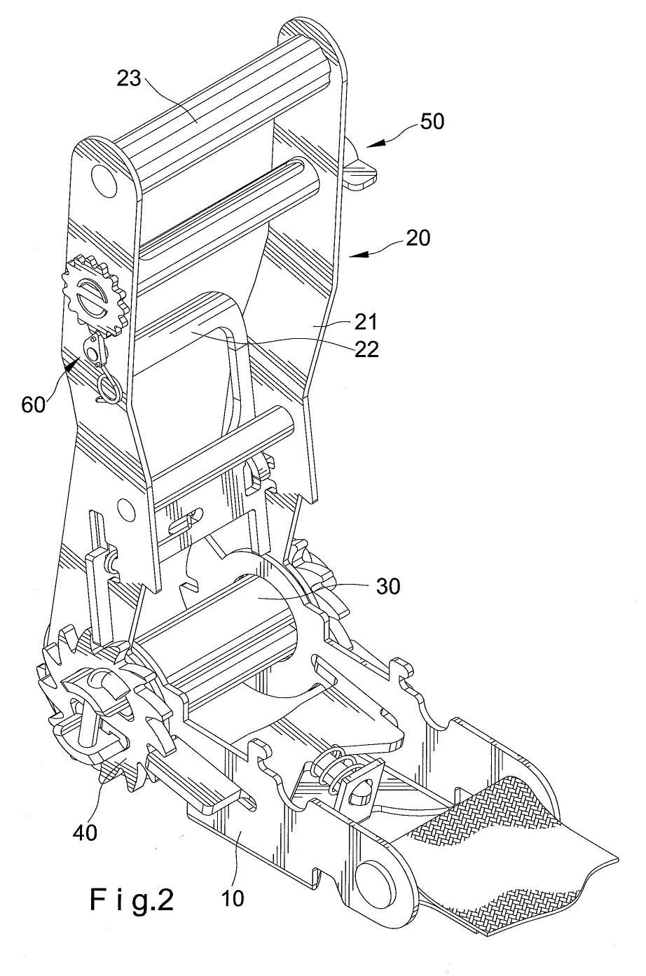

FIGS. 1 and 2 show a tensioning apparatus in accordance with the present invention. The tensioning apparatus includes a frame 10, a lever 20 and a first shaft 30 received by the frame 10 and the lever 20. The first shaft 30 is rotatable on the frame 10 by pivoting the lever 20 with respect to the frame 10. Two ratchet wheels 40 are connected to the first shaft 30. Additionally, the two ratchet wheels 40 are rotatable with the first shaft 30 during pivot of the lever 20.

The lever 20 includes a pair of cams 21 spaced from each other. The first shaft 30 is installed between and interconnects the cams 21. The cams 21 further include a gripping portion 23 installed therebetween, and the gripping portion 23 is used to pivot the lever 20. Additionally, a detent 22 is movably installed on the lever 20 and is moveable between an operative position in engagement with the ratchet wheels 40 in order to rotate the first shaft 30 and an idle position away from the ratchet wheels 40.

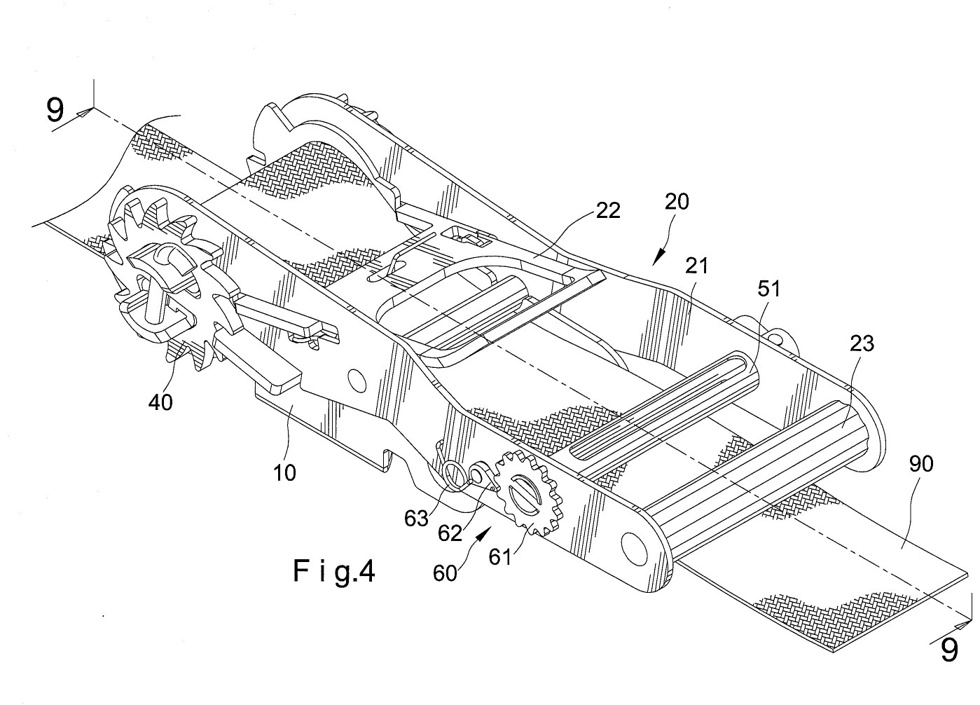

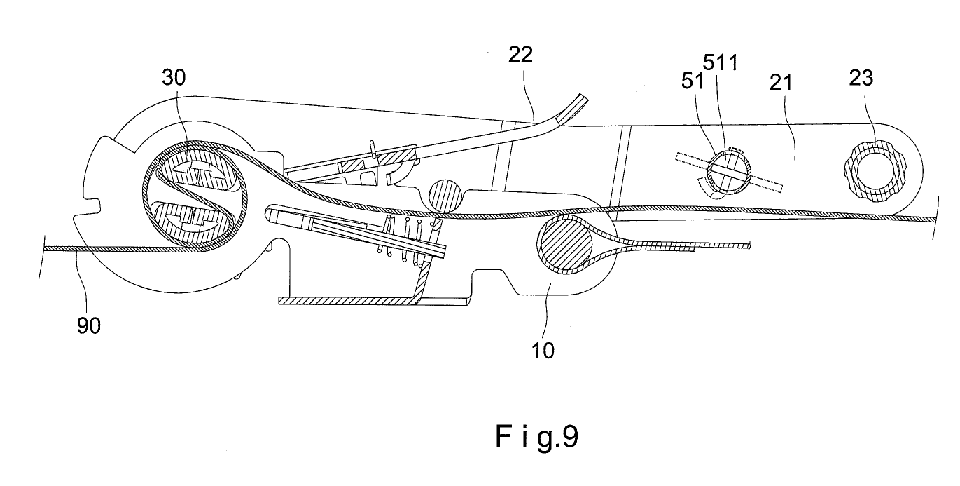

The tensioning apparatus is adapted to tension a strap 90 and, the strap 90 is inserted through the first shaft 30 and includes first and second portions extending in opposite directions, as shown in FIG. 4 or 9. It is understood that the first portion of the strap 90 is adapted to be collected on the first shaft 30 by reciprocally pivoting the lever 20. Additionally, FIG. 9 shows that the lever 20 is in a stowed position after finishing collecting the strap 90.

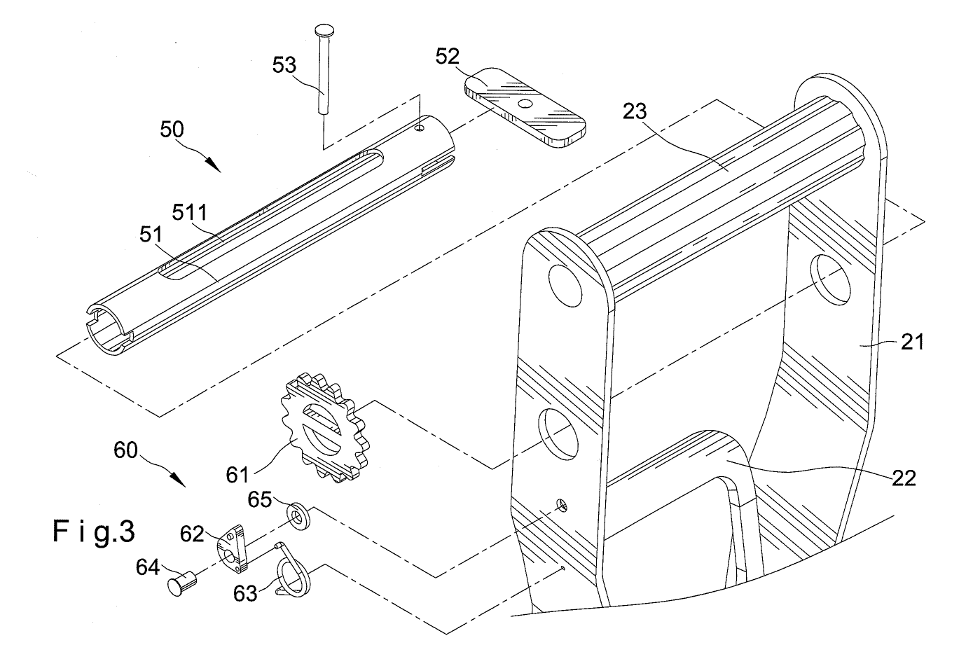

The tensioning apparatus further includes a reeling device 50 for collecting the second portion of the strap 90 and a ratcheting mechanism 60. The reeling device 50 is installed between and interconnects the cams 21. The ratcheting mechanism 60 is installed on one of the cams 21. FIG. 3 shows that the reeling device 50 includes a second shaft 51, and user can operably rotate the second shaft 51. The second shaft 51 is installed between the cams 21. In this preferred embodiment, the second shaft 51 is disposed between the gripping portion 23 and the detent 22. The reeling device 50 may includes a handle 52 connected to the second shaft 51 for facilitating user to rotate the second shaft 51. Additionally, the handle 52 is preferably disposed outside a space delimited between the cams 21 so that user can easily operate the handle 52. Also, a fastener 53 may be used to secure the handle 52 with the second shaft 51. Furthermore, the second shaft 51 may include a slot 511 for facilitating attachment of the second portion of the strap 90 with the second shaft 51.

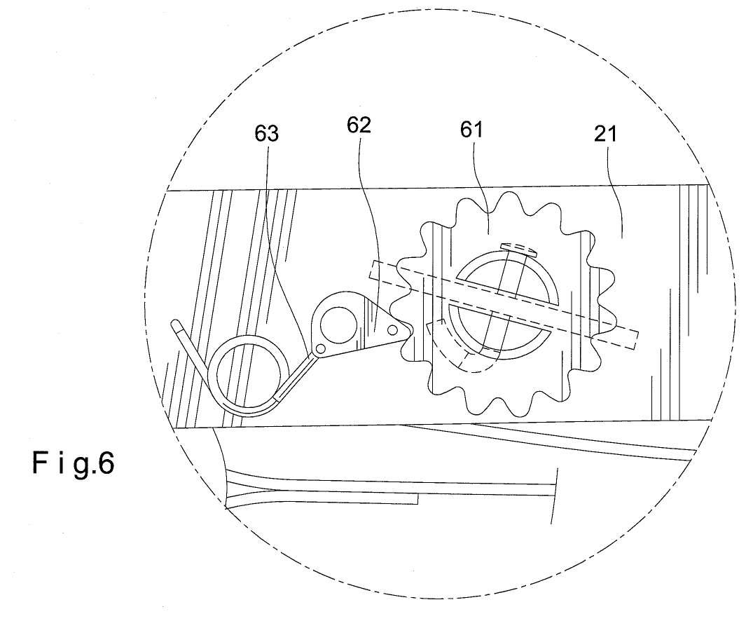

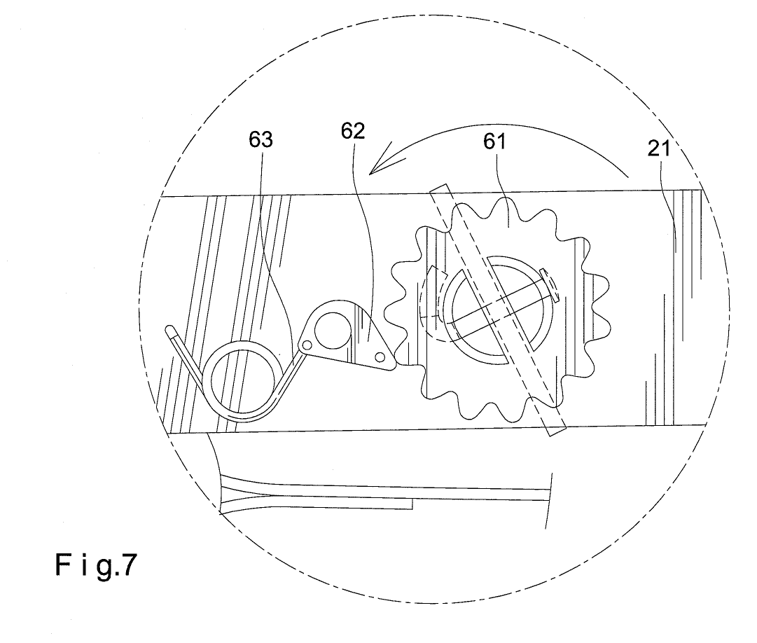

FIG. 3 also shows that the reeling device 60 includes a ratchet member 61, a pawl 62, and an elastic element 63. The ratchet member 61 includes a plurality of teeth. Additionally, the ratchet member 61 is mounted on the second shaft 51 and is rotated with the second shaft 51 as the second shaft 51 is rotated. The pawl 62 is engaged in a space between two of the plurality of teeth of the ratchet member 61, as shown in FIG. 6. FIG. 6 also shows that the elastic element 63 has one end mounted on the cam 21 and another end connected with the pawl 62. Thus, when the ratchet member 61 is rotated, the pawl 62 is disengaged from the space and biasably urged to engage in another space by the elastic element 63, as shown in FIG. 7. Further, the pawl 62 is securely mounted on the cam 21 by a connector 64. Furthermore, a spacer 65 may be used between the pawl 62 and the cam.

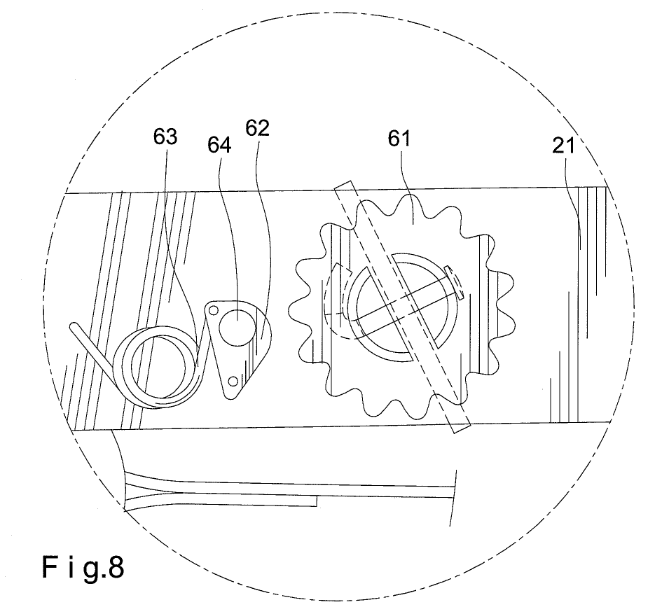

FIG. 8 shows that the pawl 62 is adapted to be retained at a position disengaged from the ratchet member 61. Under this circumstance, user can unreel the second portion of the strap 90 collected on the reeling device 50.

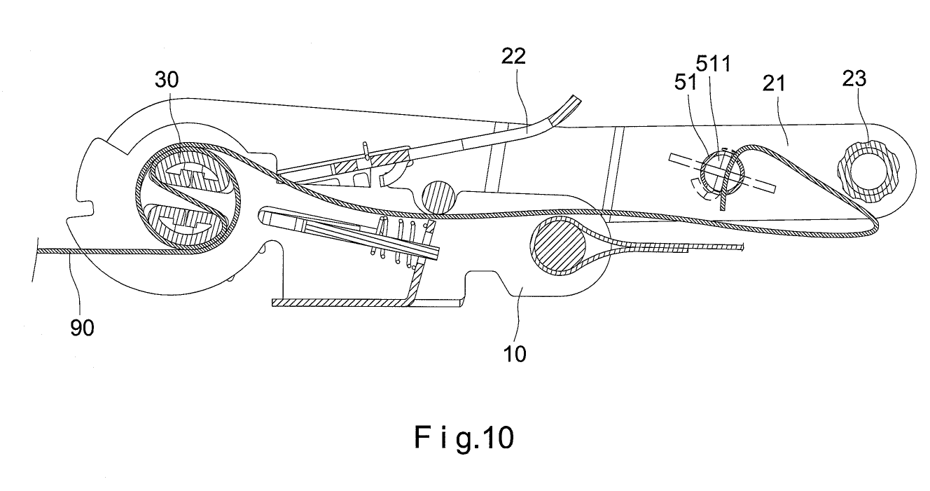

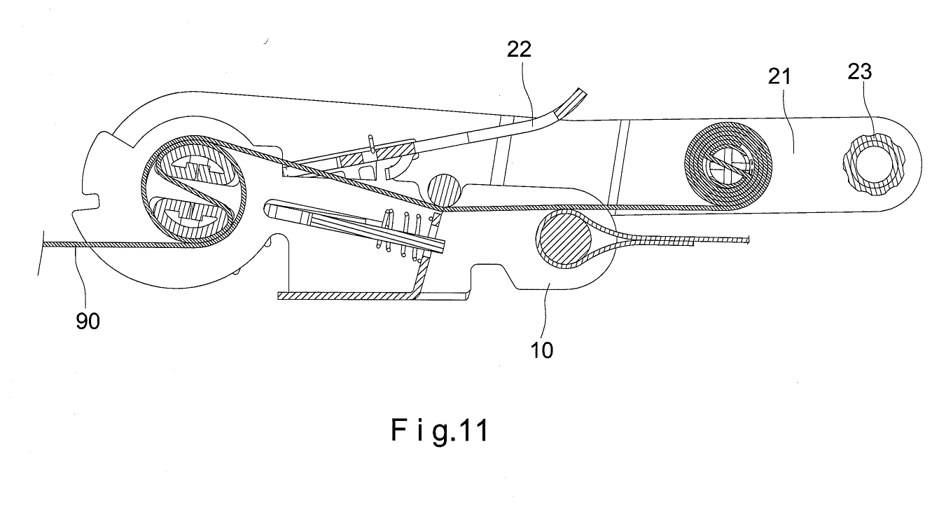

Referring to FIGS. 9 through 11, when collecting the second portion of the strap 90, the strap 90 is inserted through the slot 511, and the strap 90 is collected on the second shaft 51 of the reeling device 50 by operating the handle 52 to rotate the second shaft 51.

It is an aspect of the present invention that the reeling device 50 is used for collecting the second portion of the strap 90.

It is another aspect of the present invention that the gripping portion 23 of the lever 20 is used to pivot the lever 20, and the strap 90 on the reeling device 50 will not obstruct user to hold the gripping portion 20.

It is a further aspect of the present invention that the ratcheting mechanism 60 facilitates collection of the second portion of the strap 90 by preventing the second shaft 51 from turning in a direction to unreel the strap 90.

While the specific embodiments have been illustrated and described, numerous modifications come to mind without significantly departing from the spirit of invention and the scope of invention is only limited by the scope of accompanying claims.

What is claimed is:

1. A tensioning apparatus comprising:
a frame;
a first shaft rotatably mounted on the frame;
a lever connected with the first shaft and operably pivoted with respect to the frame to rotate the first shaft, the lever further including a gripping portion mounted thereon and used for pivoting the lever;
a reeling device including a second shaft rotatably mounted on the lever;
a ratcheting mechanism including a ratchet member mounted on the second shaft and rotated with the second shaft, a pawl, and an elastic element biasably engaging the pawl with the ratchet member;
a strap inserted through the first shaft and including first and second portions extending in opposite directions, with the first shaft rotatable to collect the first portion of the strap, and with the reeling device rotatable to collect the second portion of the strap; and
wherein engagement between the ratchet member and the pawl provides a step-by-step effect and facilitates collection of the second portion of the strap by preventing the second shaft from turning in a direction to unreel the strap.

2. The tensioning apparatus as claimed in claim 1 further including a ratchet wheel mounted on the first shaft, and a detent movably installed on the lever between an operative position in engagement with the ratchets in order to rotate the shaft and an idle position away from the first ratchet.

3. The tensioning apparatus as claimed in claim 1 wherein the lever includes a pair of cams spaced from each other.

4. The tensioning apparatus as claimed in claim 3 wherein the second shaft is installed between the cams.

5. The tensioning apparatus as claimed in claim 2 wherein the second shaft is disposed between the gripping portion and the detent.

6. The tensioning apparatus as claimed in claim 1 wherein the reeling device includes a handle connected to the second shaft for facilitating user to rotate the second shaft.

7. The tensioning apparatus as claimed in claim 1 wherein the second shaft includes a slot for facilitating attachment of the second portion of the strap with the second shaft.

8. The tensioning apparatus as claimed in claim 1 wherein the ratchet member includes a plurality of teeth, and wherein the pawl is engaged in a space between two of the plurality of teeth of the ratchet member and the pawl is disengaged from the space and biasably urged to engage in another space by the elastic element during rotation of the ratchet member.

9. The tensioning apparatus as claimed in claim 3 wherein the first shaft is installed between and interconnects the cams.

10. The tensioning apparatus as claimed in claim 3 wherein the gripping portion is installed between and interconnects the cams.

11. The tensioning apparatus as claimed in claim 1 wherein the pawl is operably moveable between a first position in engagement with the ratchet member and a second position disengaged from the ratchet member, and wherein the second portion of the strap collected on the reeling device is adapted to be unreeled.

12. The tensioning apparatus as claimed in claim 1 wherein the elastic element includes a first end mounted on the lever and a second end connected with the pawl.
